(19) United States
(12) Patent Application Publication
(10) Pub. No.: US 2024/0284890 A1
(43) Pub. Date: Aug. 29, 2024

(54) METHOD AND SYSTEM FOR COUNTING BIRD PARASITES

(71) Applicant: INTERVET INC., Rahway, NJ (US)

(72) Inventors: Joep BOLWERK, Nederasselt (NL); Evert GIJTENBEEK, Wijchen (NL); Gijsbert Johan VAN DUIJN, Oss (NL); Peter JANS, De Rips (NL)

(73) Assignee: INTERVET INC., (US)

(21) Appl. No.: 18/570,341

(22) PCT Filed: Jun. 29, 2022
(86) PCT No.: PCT/EP2022/067833

§ 371 Date: Dec. 14, 2023

(30) Foreign Application Priority Data
Jun. 30, 2021 (EP) 21182663.1

(51) Int. Cl. A01M 1/02; G06T 7/00

(52) U.S. Cl. CPC A01M 1/026; G06T 7/00; A01M 2200/011; G06T 2207/30242

(57) ABSTRACT

A method for counting bird parasites (22) by capturing an image of a target area (20) that the parasites are expected to cross, and using image recognition techniques for discerning the parasites, characterized in that the target area (20) is a portion of a substrate (12) on which birds (10) are kept and which has a topography with low time variation, and the method comprises a step of counting incidents of temporary local disturbance of the topography of the target area.

### CROSS-REFERENCE TO RELATED APPLICATIONS

This application is a 371 national phase of international application no. PCT/EP2022/067833, filed Jun. 29, 2022, which claims priority of European Patent Application No. 21182663.1 filed Jun. 30, 2021, the entire contents of which are incorporated herein by reference.

### BACKGROUND OF THE INVENTION

The invention relates to a method and system for counting bird parasites by capturing an image of a target area that the parasites are expected to cross, and using image recognition techniques for discerning the parasites.

More particularly, the invention relates to a method of detecting an infestation of a poultry farm with blood mites.

At day time, the blood mites tend to hide in dark places, such as cracks and crevices in the barn where the poultry are kept. In the night, when it is dark and the chicken are resting on their perch, the mites crawl to the chicken to suck their blood. Depending on the amount of infestation, the blood loss caused to the chicken may be substantial and detrimental to their health, which results in a lower growth rate of the chicken or a lower quality of their eggs. In any case, the mites cause substantial losses to the poultry industry.

An established method of pest control comprises mixing certain chemicals, which kill the mites, into the drinking water for the chicken. However, these measures are typically be taken only when it has become known that the bam is infested. The invention therefore aims at detecting an infestation as early as possible.

### SUMMARY

It is well known in the art to detect parasites by means of electronic image recognition. For example, machine learning techniques can be utilized for distinguishing the mite from their background which may for example be the skin of the animal that is infested. In the case of bird or chicken parasites, it is however more expedient to detect the mite when they crawl over a substrate on which the birds are kept. The problem with this approach is that the substrate, e.g. the surface of a wooden perch on which the chicken are b sitting, has a relatively rough texture, which makes it difficult to distinguish the parasites from the background, in particular when the images are taken at low illumination intensity in order not to disturb the sleeping birds. It is therefore common practice that the target area of which images are captured is the floor of a box- or funnel-like detection device that has been placed in the way of the parasites and constitutes a known, preferably uniform background that contrasts well with the parasites. An example of a device of this type has been described in EP 2 931 032 Bl.

It is however relatively costly to install such detection devices at suitable places. In particular, care should be taken that no cleavages are formed between the detection device and the substrate on which it is installed, because otherwise the mites would tend to crawl along these cleavages and thereby to circumvent the floor of the detection device.

It is therefore an object of the invention to provide a low-cost and nevertheless efficient method of counting bird parasites.

In order to achieve this object, the method according to the invention is characterized in that the target area is a portion of a substrate on which birds are kept and which has a topography with low time variation, and the method comprises a step of counting incidents of temporary local disturbance of the topography of the target area.

The invention takes advantage of the fact that the parasites are crawling, i.e. moving over the target area so that the disturbance that a crawling parasite causes at a given location of the substrate is only temporary. In spite of a low contrast between the parasites and the background, these temporary disturbances can easily be detected by comparing images that have been taken at different times. This method requires, however, that the substrate itself has a topography that is stable in time, i.e. does not undergo substantial changes from one image to the other, typically being stable in a time period of up to 12-24 hours (which equates the term “low time variation”). This requirement may not be fulfilled for example by a substrate consisting of mulch (which may be stirred by the chicken). It would be fulfilled, however, by a substrate that is constituted by a wooden perch, for example, where the only changes in the topography are a gradual accumulation of stains and dust on the surface and the occasional appearance of new scratches that have been caused by the chicken claws.

In another aspect, the object of the invention is achieved by a system that is configured for carrying out the method described above.

More specific optional features of the invention are indicated in the dependent claims.

In one embodiment, the images of the target area may be taken in the form of short video sequences permitting a direct detection of the movement of the crawling parasites. In another embodiment, the images may consist of individual frames that are taken in larger time intervals. In that case, a crawling mite will cause a local disturbance at a certain location in one image, but this disturbance will no longer be visible in the next image because the mite has moved-on in the meantime.

Dependent upon the average crawling speed of the mites and the rate at which the images are taken, it may happen that a mite is detected in a plurality of subsequent images, so that the count would have to be corrected for such double or multiple counts in order to obtain a valid measure for the amount of infestation. Nevertheless, it may be advantageous to use an image capture rate that is so high that, from one image to the other, the mites have travelled only a relatively small distance which is however significantly larger than the dimension of an individual mite. Then, the movements of the mites can safely be tracked and a valid count can be obtained. This method has the further advantage that the sensitivity is increased due to the redundance of the repeated detections.

In order to avoid disturbing the chicken, it is possible to use a relative low level of illumination in conjunction with an extended exposure time for capturing the images. Then, the movements of the mites will cause the local disturbances to be somewhat blurred. This, however, can even be turned into an advantage because the disturbances will then readily be visible as locations with reduced contrast in a contrast-enhanced image.

In order to improve the distinction between the mites and the background, it may also be helpful to generate a reference image by stacking a plurality of images taken at different times. Due to the movements of the mites, the stacking procedure will only enhance the background features but not the mites, so that the reference image will eventually consist of almost pure background. Then, when this background image is subtracted from a captured image, the background will be almost invisible and the disturbances (mites) will show up very clearly.

Since the method according to the invention requires only the installation of the camera at a suitable position, the installation costs are reduced significantly. It is possible, however, to combine the camera with other sensors for obtaining deeper insight into the amount, the conditions and mechanisms of infestation. Examples of additional sensors comprise temperature sensors, humidity sensors, air pressure sensors, light intensity sensors (e.g. for determining the activation time of the counting device and/or for studying the impact of light intensity onto the behavior of the mites). A position and/or acceleration sensor may be provided for detecting any possible changes in the positioning and the orientation of the camera. Acoustic sensors may be provided for recording the noise made by the chicken, e.g. in order to detect whether this noise correlates with the activity of the mites.

The method and system according to the invention can provide farmers with an early warning in case of an infestation. Beyond this, the method and system may be used for documenting the time evolution of the infestation and to provide a simple gauge for assessing the amount of infestation. These data may then be used further for correlating the amount of infestation with environmental conditions and/or with the growth rate of the chicken or other indicators for the health of the chicken.

If a plurality of systems according to the invention are installed in the same barn or in different barns, possibly of different farmers, it is also possible to collect statistical data that show how and from where an infestation spreads and which factors enhance or suppress the infestation.

### BRIEF DESCRIPTION OF THE DRAWINGS

An embodiment example will now be described in conjunction with the drawings, wherein:

FIG. 1 is a schematic perspective view of a counting system according to the invention;

FIGS. 2 and 3 are examples of images captured by the counting system according to FIG. 1;

FIG. 4 is an example of a reference image obtained by stacking a plurality of images of the type shown in FIGS. 2 and 3;

FIG. 5 is an image from which the reference image of FIG. 4 has been subtracted after image capture;

FIG. 6 is a flow diagram of a method according to the invention; and

FIG. 7 is a block diagram of a system according to the invention.

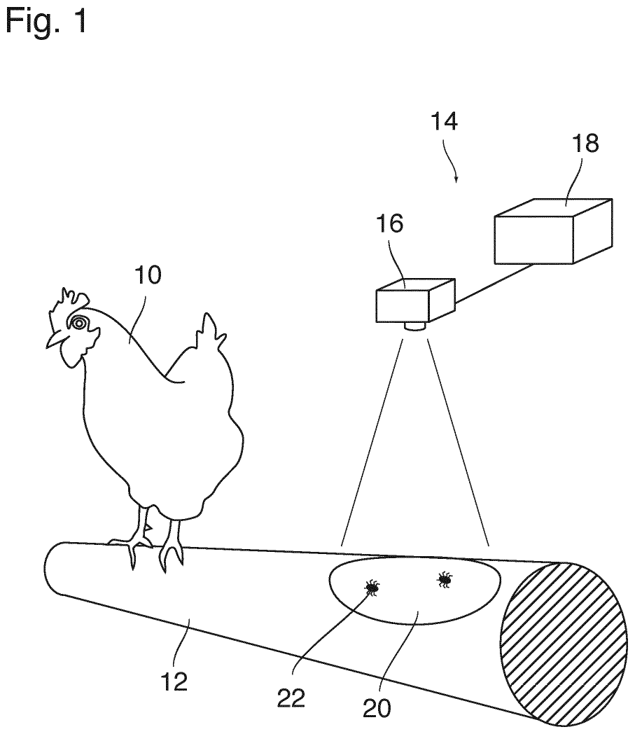

FIG. 1 shows a chicken 10 sitting on a wooden perch 12 on which it sleeps in the night. A parasite counting system 14 comprising at least a digital camera 16 and a processing device 18 has been installed in a suitable position so as to monitor a certain target area 20 on the perch 12. The camera 16 has an integrated illumination system for illuminating the target area 20 with visible or infrared light, especially in the night, when mites 22 tend to crawl along the perch in order to attack the chicken. The processing device 18 is configured to analyze the images taken by the camera 16 and to identify and count the mites 22 that were present in the target area 20 at the time the image was taken.

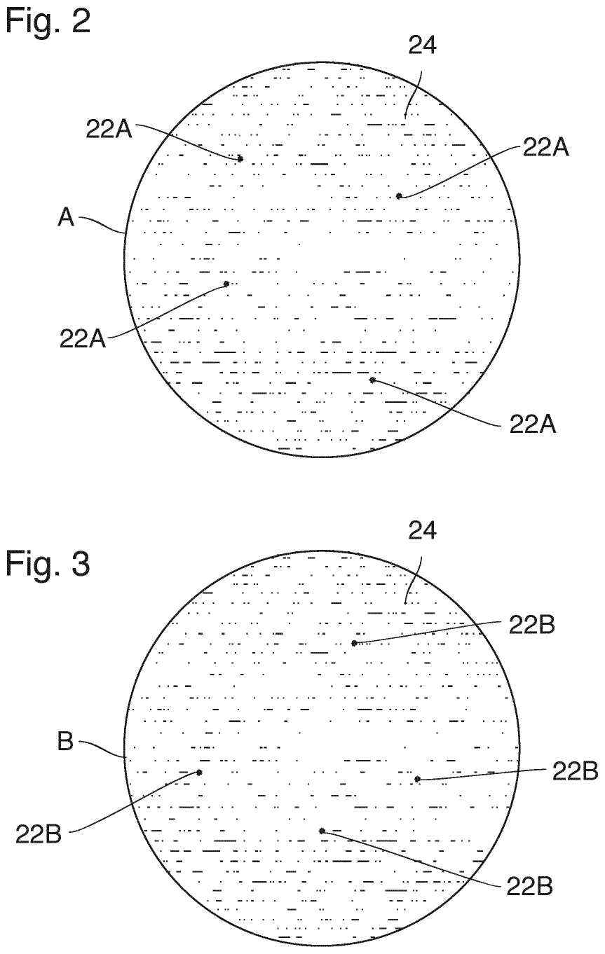

FIGS. 2 and 3 are examples of images A and B taken by the camera 16 at different times. The two images A and B show an essentially identical background 24 consisting mainly of the texture of the wooden surface of the perch in the target area 20. Image A further shows four mites 22A that have crossed the target area at the time the image was taken.

The image B also shows four mites 22B at positions that are different from the positions of the mites 22A. The mites 22B may or may not be identical with the four mites 22A shown in image A. That will depend upon the time difference between the moments at which the images A and B have been captured.

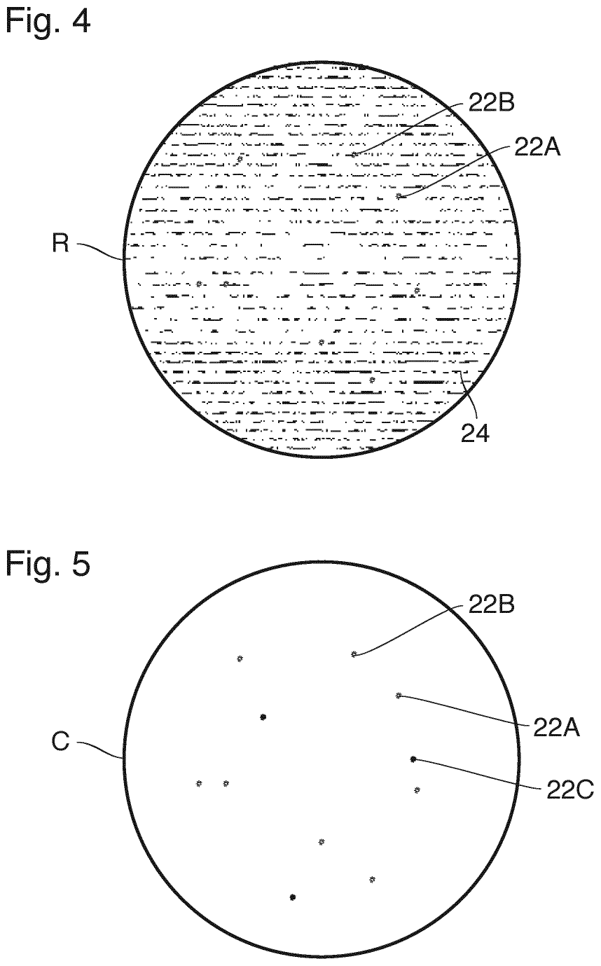

FIG. 4 shows a reference image R that has been obtained by stacking the images A and B one upon the other and then renormalizing the brightness of the image. As a result, the features of the background 24 which is essentially the same in both images appear enhanced, whereas the mites 22A, 22B have become fainter. This stacking procedure may obviously be extended to a larger number of images, with the result that the mites 22A, 22B and other mites that have each been included in only one of the images become almost invisible.

FIG. 5 shows an example of another image C that has been captured at a later time than the images A and B and from which the reference image R has been subtracted. As a result, the background 24 is eliminated almost completely in image C and what remains are only three mites 22C that have been captured in the image C, as well as faint “ghosts” (i.e. negative images) of the mites 22A and 22B. It will be appreciated that these ghosts would be even fainter if the number of stacked images had been larger than two.

Then, conventional image processing and/or machine learning techniques may be employed for assessing the intensities and sizes of the objects or disturbances that are visible in image C. The ghost images of the mites 22A and 22B may be eliminated by comparing the intensities of these images to a threshold. The same applies to other disturbances such as dust particles that have been settled on the target area between the capture times of images B and C. Then, only the mites 22C in the image C remain. The dimensions of these local disturbances may be compared to upper and a lower threshold values, and a disturbance will only count as a mite if the dimensions are within reasonable limits. Thus, large-area disturbances, i.e. a shadow of the chicken 10 falling on the target area, would also be eliminated. Then, the mites 22C that have passed the threshold tests will be counted so as to constitute a measure for the amount of infestation.

There are several strategies that may be employed for avoiding double or multiple counts. One strategy is to make the image capture rate so small that it can be excluded that two images captured one after the other show the same mites. This, however, may C degrade the overall sensitivity of the system.

According to another strategy, the capture rate is adapted to the average crawling speed of the mites such that each mite crossing the target area 20 will be photographed three, four or five times, for example. Then, by comparing the last three to five images, it is possible to track the movements of the individual mites and to determine with high accuracy the number of mites that have crossed the target area. This approach has the additional advantage that more information is obtained about the behavior of the mites, e.g. the average crawling speeds, and this information may then be used for optimizing the algorithm further.

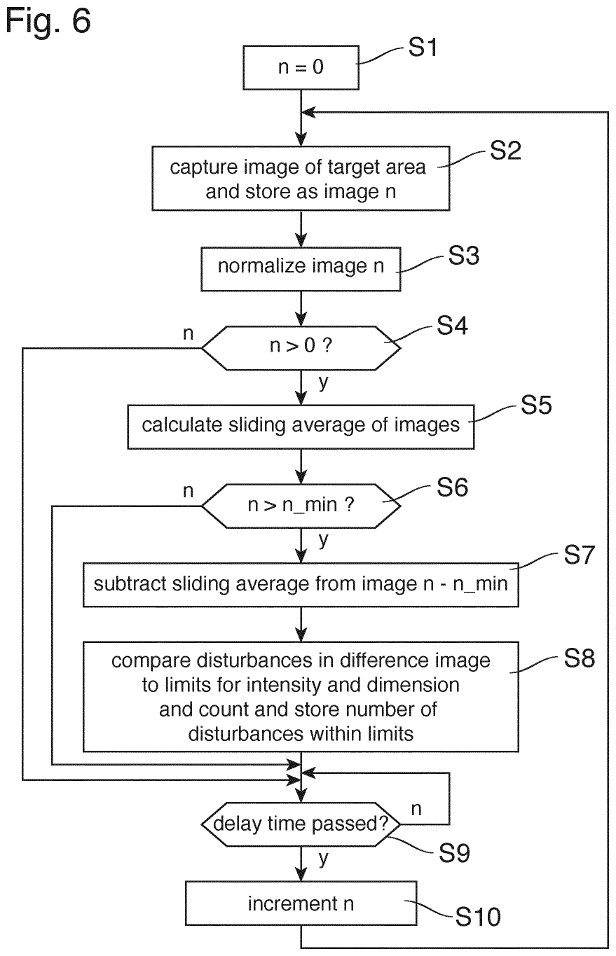

FIG. 6 is a flow diagram of an example of a counting algorithm according to the invention.

In step S1, an image counter n is initialized with n=0. Then, an image of the target area 20) 20 is captured and stored in step S2, and the current content n of the image counter is assigned to that image.

Thereafter, the stored image is normalized in step S3.

In step S4, it is checked whether the image counter n (which will be incremented later in the process) has already reached a value larger than 0. If that is the case (y), a sliding average of the captured images is calculated in step S5. If n=1, then the calculation of the sliding average may simply consist of the stacking of the first two images as in FIGS. 2 to 4. Then, in the next execution of step S4, another image (n=3) will be added, and so on. If the stack has reached a certain height of, e.g., ten images, then it is possible in one embodiment to subtract the first image (n=0) from the stack and to add the new image instead, so that the stack will always contain the last ten images.

In another embodiment, the first execution of the step S5 may comprise weighting the first image (n=0) with a certain weight factor, e.g. 0.9, and then adding the new image (n=1) with a weight factor of 1.0, and then renormalizing the image so as to obtain the reference image R. Then, in the subsequent executions of step S5, the previous reference image R will be weighted with the weight factor of 0.9, and the respective new image will be added with full weight. Thus, the reference image (the sliding average) will always be dominated by the last few images that have been captured, whereas the information from the first few images (n=0, 1, . . . ) will fade exponentially.

In step S6, it is checked whether the image counter n has reached a certain value n_min at which the reference image has been averaged over a sufficient number of images so that it will be essentially free from “ghosts”. If that condition is fulfilled, the reference image will be subtracted from the image with the number n-n_min in step S7. In the first execution of this step, n is equal to n_min, and the reference image will be subtracted from image n=0, i.e. the image that was captured first will be assessed (retrospectively).

Then, in step S8, the disturbances that remain in the difference image (image θ−image R) are checked against the various thresholds for intensity and dimension, as was described before, and the remaining disturbances found in the difference image will optionally be subjected to a tracking routine for avoiding double counts, and then a count of mites will be stored for that image.

If it is found in step S4, that the value of n is 0, then the steps S5 to S8 are skipped. Similarly, if it is found in step S6 that the condition is not fulfilled, the steps S7 and S8 will be skipped.

Then it is checked in step S9 whether a certain delay time has passed. It will be understood that this delay time defines the image capture rate. The step S9 is repeated until the specified delay time has passed, and then the image counter n is incremented by one in step S10, and the routine loops back to step S2. In this way, a mite count is established and stored for each image that has been captured, and the development of the mite counts over time can be stored and displayed.

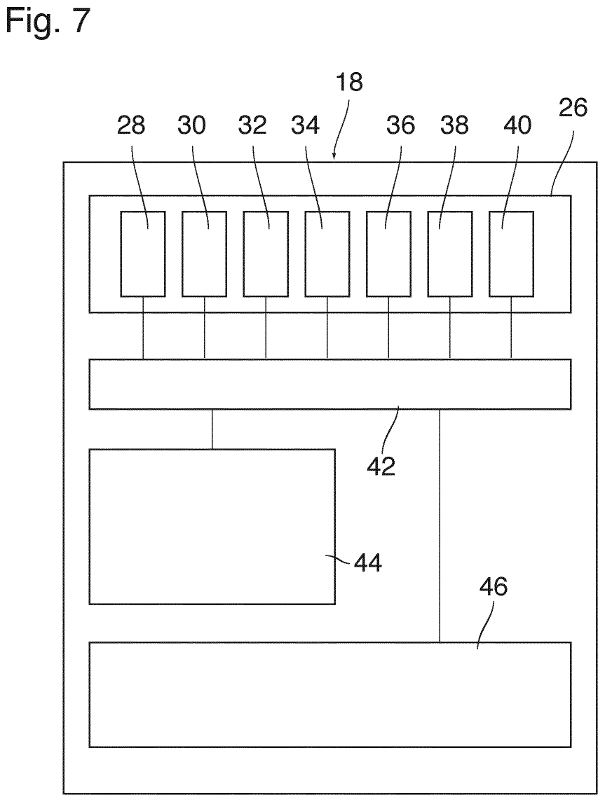

FIG. 7 is a block diagram of the processing device 18 shown in FIG. 1. An input section 26 of the processing system includes a camera interface 28 receiving image data from the camera 16. The input section further includes a temperature sensor 30 for sensing the temperature in the direct environment of the perch 12, a humidity sensor 32 for sensing the air humidity in that environment, an air pressure sensor 34, a brightness sensor 36 measuring the brightness of the illuminated target surface 20 (the brightness sensor may optionally be integrated into the camera 16), a position and acceleration sensor 38 detecting the position and possible movements of the entire counting system, and an acoustic sensor 40 for capturing noises of the chicken. The counting system or at least the camera 16 may be installed on a rig that can be adapted to position the camera in different positions around the perch 12, so that, by referring to information from the position sensor 38, it is possible to find out whether the mites prefer to crawl on the top side or the bottom side of the perch. This information can then be utilized in further installations for optimizing the camera positions.

A processing unit 42 processes the image data provided by the camera 14 as well as the sensor data from all the other sensors in the input section 26 and stores the results, in particular the history of the mite counts, in a memory 44.

Statistical evaluation tools for evaluating the contents of the memory 44 under different aspects may also be implemented in the processing unit 42, so that the mite counts and the sensor data may be subjected to various kinds of statistical analysis.

Further, the data stored in the memory 44, including the results of the analysis, may be transmitted to a communication section 46 which communicates with a user interface (not shown), e.g. a smartphone app, so that the user can retrieve the counts and the analysis results from the memory 44. Further, the processing unit 42 may have an implemented alarm system that can alert the user in the event of a first detection of mites or other relevant events by sending a push message to the user interface.

1. A method for counting bird parasites (22) by capturing an image of a target area (20) that the parasites are expected to cross, and using image recognition techniques for discerning the parasites, characterized in that the target area (20) is a portion of a substrate (12) on which birds (10) are kept and which has a topography with low time variation, and the method comprises a step of counting incidents of temporary local disturbance of the topography of the target area.

2. The method according to claim 1, wherein the target area is a portion of a surface of a perch (12).

3. The method according to claim 1, comprising a step of generating a reference image (R) which shows a background (24) in the form of a texture of the substrate, whereas other image features are suppressed, and a step of subtracting the reference image from a captured image (C), thereby to suppress the background (24).

4. The method according to claim 1, wherein a capture rate with which the images (A, B, C) are captured, is adapted to an average crawling speed of the parasites (22) such that each parasite crossing the target area (20) is photographed several times, and the step of counting comprises a step of tracking movements of the local disturbances that represent the parasites.

5. A system (14) for counting bird parasites (22), the system comprising a camera (16) and a processing device (18) arranged and configured to carry out the method according to claim 1.

6. The system according to claim 5, comprising at least one of:
a temperature sensor (30),
a humidity sensor (32),
an air pressure sensor (34),
a light sensor (36),
a position and/or acceleration sensor (38),
an acoustic sensor (40),
wherein the processing device (18) is configured to correlate the counts of the parasites to the data provided by said sensors.

7. A software product comprising program code that, when run on a processing device (18), causes the processing device to perform the method according to claim 1.

8. A system for counting bird parasites (22) the system comprising a camera (16) a processing device (18) arranged and configured to capture an image of a target area (20) that the parasites are expected to cross, and use image recognition techniques to discern the parasites, characterized in that the target area (20) is a portion of a substrate (12) on which birds (10) are kept and which has a topography with low time variation, wherein the system counts incidents of temporary local disturbance of the topography of the target area.

9. The system according to claim 8, wherein the target area is a portion of a surface of a perch (12).

10. The system according to claim 8, wherein the system generates a reference image (R) which includes a background (24) in the form of a texture of the substrate, whereas other image features are suppressed, and wherein the system substracts the reference image from a captured image (C), thereby to suppress the background (24).

11. The system according to claim 10, wherein the system has a capture rate with which the images (A, B, C) are captured, and wherein the capture rate is adapted to an average crawling speed of the parasites (22) such that the system images each parasite crossing the target area (20) several times, and wherein the system tracks movements of the local disturbances.
